(19) United States
(12) Patent Application Publication
(10) Pub. No.: US 2010/0090866 A1
(43) Pub. Date: Apr. 15, 2010

(54) Optical Distress Beacon For Use In Space Environments

(76) Inventors: Howard Chen, San Gabriel, CA (US); Andrew Joseph Giles, Newport, OR (US); Nathaniel Pinckney, Lake Forest, CA (US); Sarah Harris, San Diego, CA (US); Andrew Danowitz, Saugus, CA (US); Samuel Seth Osofsky, Rancho Palos Verdes, CA (US)

Correspondence Address: HENRICKS SLAVIN AND HOLMES LLP;SUITE 200, 840 APOLLO STREET, EL SEGUNDO, CA, 90245, US

(21) Appl. No.: 12/250,294

(22) Filed: Oct. 13, 2008

(51) Int. Cl. B64F 1/18

(52) U.S. Cl. 340/953

(57) ABSTRACT

A beacon system includes emitter devices, driver circuitry configured for controlling the emitter devices, and at least one processor programmed to receive and process one or more inputs and control the driver circuitry to actuate the emitter devices. In an example embodiment, the emitter devices include visible light sources that are oriented to provide omni-directional visibility for the beacon system. In an example embodiment, components of the beacon system including the emitter devices, driver circuitry and at least one processor are configured such that in a space environment heat generated by the beacon system is dissipated sufficiently well to prevent the beacon system from overheating.

### STATEMENT OF GOVERNMENT INTEREST

The invention was made with Government support under contract No. FA8802-04-C-0001 by the Department of the Air Force. The Government has certain rights in the invention.

### TECHNICAL FIELD

The invention relates generally to distress beacons and, in particular, to beacon systems for use in space environments.

### BACKGROUND ART

As construction work in space becomes more prevalent, the risk of an accident or emergency involving an astronaut engaged in extra-vehicular activities increases. To provide aid during such an event, it is desirable to have a mechanism for indicating or somehow communicating notice that an accident, emergency or other circumstance of concern has occurred.

Various warning beacons are known; for example, beacons that incorporate bright light sources designed to warn aircraft or other vehicles of terrain related obstacles. However, such beacons are typically stationary and generally are not designed to be viewed from all observer geometries. Unfortunately, by way of example, an astronaut using such a distress beacon is unlikely to be capable of maintaining a fixed orientation with regards to rescuers.

Additionally, it should be appreciated that traditional aircraft warning beacon designs are unfit for use as a space-based visual distress beacon because they would not be able to dissipate a sufficient amount of heat in a zero-atmosphere environment.

Cospas-Sarsat compatible distress radio-beacons are used by vehicles and individuals to generate a distress and homing signal in the event of an emergency. These beacons generally transmit signals in the 121.5 MHz and 406 MHz frequency spectrums and can be tracked by the Cospas-Sarsat satellite-based search and rescue system. This class of device uses radio signals for location determination.

It would be useful to be able to provide a beacon system that is capable of generating an omni-directional distress or other indicator and that is suitable for operation in a zero-atmosphere environment.

### SUMMARY OF THE INVENTION

Example embodiments described herein include beacon systems that provide an omni-directional visible (or other) indication that an accident, emergency or other circumstance of concern has occurred. In example embodiments, beacons systems are configured to also facilitate communication of information that is not necessarily related to a distress or emergency condition (e.g., when a primary communication mechanism has failed). Example embodiments of beacon systems described herein can also be used to provide markers for any locations of interest, including those unrelated to emergencies. In example embodiments, distress indications (or indications of other information) generated by the beacon systems described herein, whether implemented as a single component or distributed components, are observable (e.g., in the visible or IR regions) from all geometric orientations of the astronaut.

Example embodiments described herein include beacon systems that are configured to survive in vacuum environments, such as the zero-atmosphere environment of space, and to radiate, in such environments, a sufficient amount of the heat generated by the beacon system through black-body radiation to prevent the beacon system from overheating. Example embodiments of beacon systems described herein are configured to dissipate a sufficient amount of heat to operate (e.g., at steady state) in a zero-atmosphere environment. In example embodiments, the beacon system is designed to operate in and be compatible with the space environment, which requires a design that efficiently dissipates heat, efficiently converts DC power to the distress signal, easily allows for choosing the modes of operation, and minimally obstructs the astronaut (low mass and low profile) during the performance of space-walk efforts.

In an example embodiment, a beacon system includes emitter devices including visible light sources that are oriented to provide omni-directional visibility for the beacon system, driver circuitry configured for controlling the emitter devices; and at least one processor programmed to receive and process one or more inputs and control the driver circuitry to actuate the emitter devices.

In an example embodiment, a beacon system includes emitter devices, driver circuitry configured for controlling the emitter devices, and at least one processor programmed to receive and process one or more inputs and control the driver circuitry to actuate the emitter devices, wherein components of the beacon system including the emitter devices, driver circuitry and at least one processor are configured such that in a space environment heat generated by the beacon system is dissipated sufficiently well to prevent the beacon system from overheating.

In an example embodiment, a beacon system includes a supporting structure (such as a space suit or a satellite) and multiple beacon modules that are secured to the supporting structure, each of the beacon modules including emitter devices including at least one visible light source that are oriented to provide omni-directional visibility for the beacon system, driver circuitry configured for controlling the emitter devices, and a processor programmed to receive and process one or more inputs and control the driver circuitry to actuate the emitter devices. In another example embodiment, components of the beacon modules including the emitter devices, driver circuitry and processors are configured such that in a space environment heat generated by the beacon modules is dissipated sufficiently well to prevent the beacon modules from overheating.

### BRIEF DESCRIPTION OF THE DRAWINGS

FIG. 1 illustrates an example embodiment of a beacon system integrated with a space suit;

FIG. 2 illustrates an example embodiment of a beacon system integrated with a satellite;

FIG. 3 is a block diagram of an example embodiment of a beacon system;

FIG. 4 shows an example add-on board embodiment of a beacon system or module;

FIG. 5 is a block diagram of an example embodiment of a beacon system configured to support point-multipoint node communication;

FIG. 6 is an electrical schematic of an example embodiment of LED driver circuitry; and

FIG. 7 illustrates an example output scheme to efficiently drive multiple emitters and minimize power usage.

### DISCLOSURE OF INVENTION

Beacon systems according to the principles described herein can take a variety of forms including, but not limited to, a stand-alone, dedicated distress beacon system, a distributed arrangement of beacon modules, and an add-on design to a satellite architecture.

Example embodiments of beacon systems use different types of emitters to provide an indication (for example, of an emergency), such as emitters that generate visible light, infrared (IR), and radio frequency (RF). Example embodiments of beacon systems include a mechanism to visibly convey (directly through the use of eyes for the visible range or through an IR viewer for the IR range) the position of the astronaut or other user of the beacon system. As discussed below in greater detail, signals emitted by the beacon system may be modulated in different patterns to provide information for high-visibility and communication purposes.

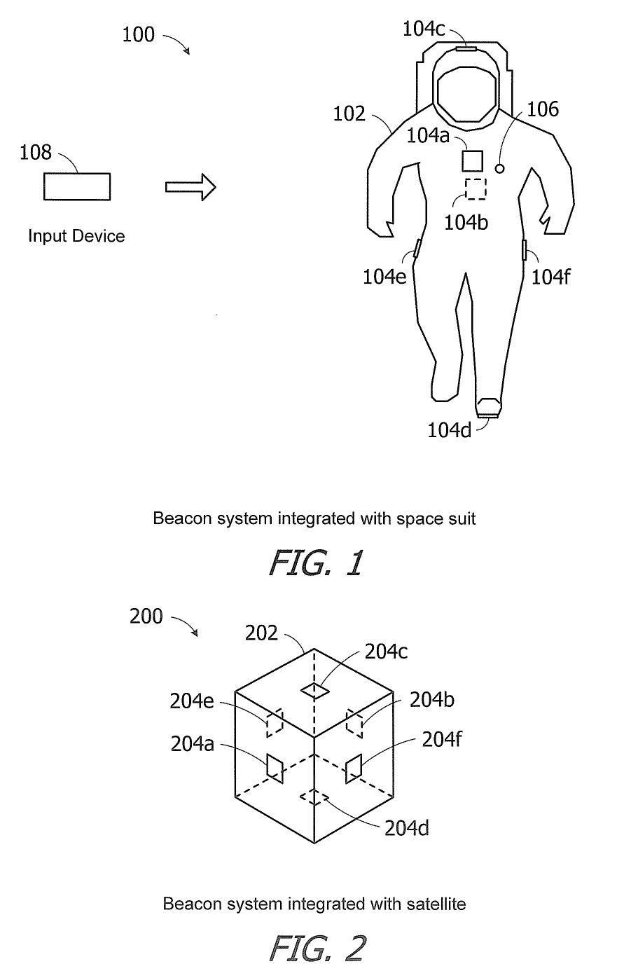

Referring to FIG. 1, in an example embodiment, a beacon system 100 is shown integrated with a space suit 102. In this example embodiment, the beacon system 100 includes beacon modules 104a, 104b (shown in dashed lines), 104c, 104d, 104e and 104f, which are secured to the space suit 102, as shown, at the front, back, top, bottom, right and left sides of the space suit 102, respectively. In an example embodiment, the beacon modules 104 include visible light sources that are oriented to provide omni-directional visibility for the beacon system 100. It should be appreciated that different configurations of beacon modules 104 can be implemented to provide omni-directional visibility, via appropriate positioning of the beacon modules 104, whether the emitters generate visible light, IR and/or RF, or some other form of indicator. It should also be appreciated that the beacon modules 104 can be configured to be connected to and/or operably interconnected with the space suit 102 in a variety of different ways.

In this example embodiment, the beacon system 100 also includes a sensor 106 configured for providing inputs to at least one of the beacon modules 104, more specifically, to at least one processor that is operatively interfaced with the beacon modules 104. By way of example, the sensor 106 is a heart monitor device, the outputs of which can be used to trigger an operational mode of the beacon system 100. The sensor 106 is interfaced with the aforementioned processor with either a wired or wireless connection.

In this example embodiment, the beacon system 100 also includes a remote control 108 configured for providing inputs to at least one of the beacon modules 104, more specifically, to at least one processor that is operatively interfaced with the beacon modules 104. By way of example, the remote control 108 includes a keypad or other user input mechanism which permits the astronaut to manually trigger an operational mode or a particular function of the beacon system 100, or enter other inputs such as Morse Code entries that are translated by the processor into control signals to drive the emitters. The beacon system 100 includes wireless links configured to facilitate communication of information between the remote control 108 and at least one processor of the beacon system 100.

The space suit 102 can more generally be described as a support structure for the beacon modules 104. Other support structures configured to be worn on the body can also be used. Other types of support structures, such as satellites, are also contemplated as being within the scope of the present invention.

Referring to FIG. 2, in an example embodiment, a beacon system 200 is shown integrated with a satellite 202 (e.g., a buoy-only cubesat). In this example embodiment, the beacon system 200 includes beacon modules 204a, 204b (shown in dashed lines), 204c, 204d (shown in dashed lines), 204e (shown in dashed lines) and 204f, which are secured to the satellite 202, as shown, at the front, back, top, bottom, right and left sides of the satellite 202, respectively. In an example embodiment, the beacon modules 204 include visible light sources that are oriented to provide omni-directional visibility for the beacon system 200. It should be appreciated that different configurations of beacon modules 204 can be implemented to provide omni-directional visibility, via appropriate positioning of the beacon modules 204, whether the emitters generate visible light, IR and/or RF, or some other form of indicator. It should also be appreciated that the beacon modules 204 can be configured to be connected to and/or operably interconnected with the satellite 202 in a variety of different ways.

In various embodiments, the emitters act as a distress beacon in at least the visible regions. In various embodiments, the emitter (or signaling) devices—in a particular beacon system or beacon module—include different types of emitter devices (e.g., visible light LED and IR LED). The emitter devices can also include RF transmitters.

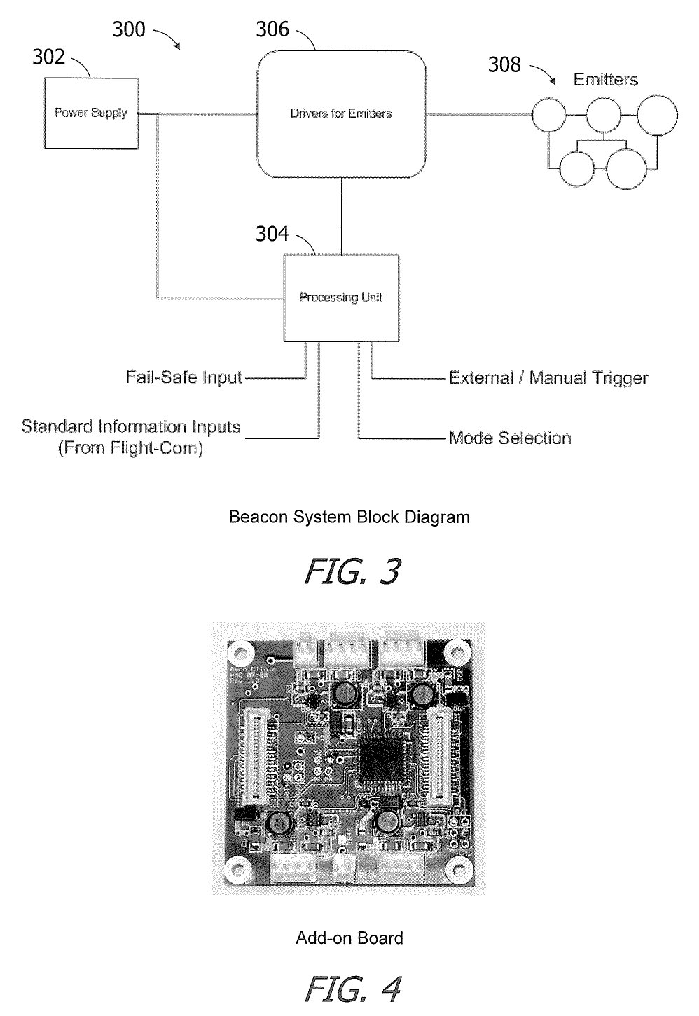

Referring to FIG. 3, in an example embodiment, a beacon system 300 includes a power supply 302, a processor (or processing unit) 304, driver circuitry (or drivers) 306, and emitters 308, configured as shown. The processor 304, for example, a PIC 18F4520 microcontroller, is configured to receive inputs such as a Fail-Safe Input, Standard Information Inputs (From Flight-Com), Mode Selection, and External/internal Trigger inputs as shown.

The processor 304 controls the LED drivers and handles all communication between the distress beacon and its external interfaces. The beacon system 300 can be triggered by the flight computer, button trigger, or fail-safe signal. With a PIC 18F4520 microcontroller used as the processor 304, these three signals are tied to three of the microcontroller's external interrupt pins. Serial communications to the rest of the cubesat are handled through the PIC's SPI and USART interfaces (Pins 1, 37, and 42-45). The PIC programming pins double as mode select pins. In an example embodiment, two dedicated pins are included and used to turn the system off in the event of accidental triggering and for use during circuit debugging. The remaining input/output pins can be dedicated to controlling the LED driver circuitry.

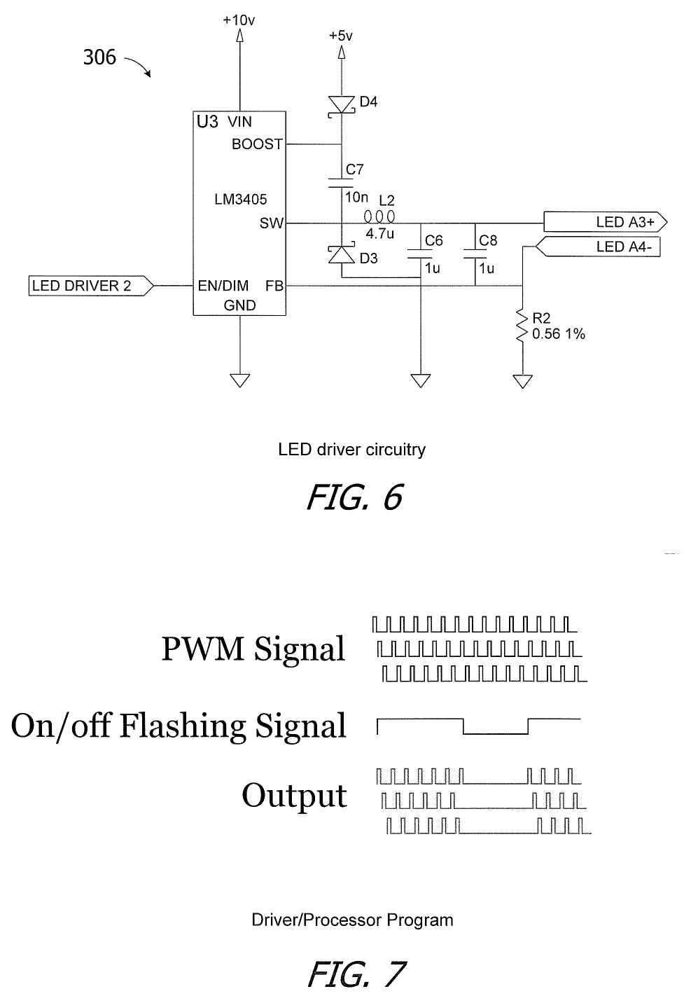

Under control of the processor 304, the driver circuitry 306 provides power to the emitters 308 (e.g., a combination of visible light and IR LEDs). Referring to FIG. 6, in an example embodiment, the driver circuitry 306 includes a LM3405 1.6 MHz, 1A Constant Current Buck Regulator configured as shown.

The LED driver circuitry is based around a buck switching current regulator. It was chosen for high efficiency and also due to its integrated enable and pulse width modulation (PWM) capabilities, as well as its relatively small footprint. The PWM capability is an efficient method to time-division multiplex the “on-time” of the emitters in order to minimize power usage and heat dissipation. The PWM rate is too fast for an observer to realize that the emitter is turned off between these pulses. In addition to the driver chip, the LED driver circuitry is composed of an inductor, a resistor, three capacitors, and two diodes configured as shown.

In this example embodiment, the driver circuitry 306 is configured for driving two LEDs in series and is suitable for both IR and visible light LED drivers. Thus, by way of example, in a beacon system with a total of eighteen LEDs, nine of the LED driver circuitry shown in FIG. 6 would be required. (In respect to such an example embodiment, for greater clarity, only a single driver chip is shown in FIG. 6.)

FIG. 4 shows an example add-on board embodiment of a beacon system or module. By way of example, a beacon system or module can be designed in compliance with the add-on board specifications for a cubesat, including connectors for use in communicating with the cubesat flight computer, as well as connectors for connecting the distress beacon circuitry to externally mounted LEDs. Thus, in an example embodiment, the beacon system or module includes one or more printed circuit boards upon which the driver circuitry and processor(s) are mounted.

In an example embodiment, each beacon module is provided with at least two visible light sources (e.g., visible light LEDs). In the case of a beacon system integrated with a cubesat, in an example embodiment, at least two visible light sources (e.g., a pair of serially connected visible light LEDs) are provided at each cubesat face. Thus, given a total of two visible light LEDs per face, if one set of LEDs fails, at least one LED per cubesat face will still be visible. In an example embodiment, there is no redundancy, however, for the IR LEDs. If one IR LED driver fails, two faces will fail to display infrared light (assuming that each pair of connector pins powers two LEDs). It should be appreciated that other emitter/driver circuitry configurations can also be used.

Referring again to FIG. 4, in example embodiments, beacon systems or modules are implemented on a printed circuit board (PCB). The PCB contains the LED driver circuitry and a microcontroller to control LED signals. In an example embodiment, the board communicates with a satellite (e.g., cubesat) flight computer through connectors. In an example embodiment, a board has nine LED/current drivers total, five on the top and four on the bottom. To achieve the high density of drivers given constrained board space, components are placed symmetrically on the top and bottom layers. Most of the components are symmetric, allowing for mirroring the traces, with the exception of the current drivers and microcontroller (or processor). In the upper left corner there is only a driver on the bottom of the board.

The microcontroller is in the middle of the board. Bypass capacitors are placed between VDD and ground close to the microcontroller. Additionally, each driver has a dedicated bypass capacitor across close to its VDD input voltage and ground. Jumpers, connecting the board to the LEDs and fail-safe trigger, are placed around the perimeter of the board. The trigger button, off button, programming power, and mode select jumpers are through-holes near the inside of the board. In an example embodiment, programming pins are shared with the mode selects. Because of area constraints, the pull-up resistor for programming is connected externally from the board. Extra jumpers for VDD and ground can be added to the layout.

Because the LED drivers are switching regulators operating at 1.6 MHz, they can cause noise on nearby traces and on the power and ground planes. To reduce noise, the power and ground planes can include cutouts around the switching nodes.

Various embodiments described herein use radiative cooling to ensure sufficient transfer of heat in the zero atmosphere environment of space. Areas of high power throughput, such as the LEDs, current drivers, and traces in the PCB, in particular were analyzed to determine heat dissipation requirements. Applying the theory of heat-transfer through black-body radiation, in an example embodiment, it was determined that the heat generated by the electronics and LEDs during steady-state operation could be completely dissipated by a piece of aluminum with an external surface area of 12.0 cm². The surface area of the cubesat is 100 cm² per side, or 600 cm² total. Thus, the cubesat example embodiment of a beacon system can adequately dissipate heat generated by the LED and drivers. Thus, in an example embodiment, the beacon modules are thermally coupled to a portion of the supporting structure that is made from a material (e.g., aluminum) capable of dissipating heat generated by the emitter devices and driver circuitry. In an example embodiment, the external surface area of the portion of the supporting structure in thermal contact with the beacon module is at least 12.0 cm². It should be appreciated, however, that different systems and modules may have different heat dissipation requirements.

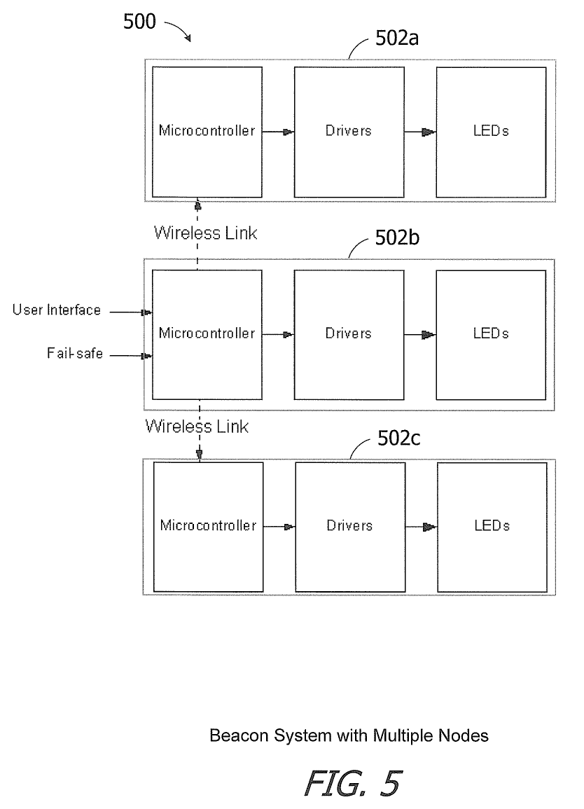

Referring to FIG. 5, in an example embodiment, a beacon system 500 with multiple modules and nodes (502a, 502b and 502c) is illustrated in block diagram form. In example embodiments, the beacon system 500 is configured to support point-multipoint node communication for modular distress beacon systems. This feature allows any part of the distress beacon system to be divided into control modules and control/subordinate nodes. Control modules contain either full or partial user and automated trigger interfaces and may also contain light emitters. Control nodes also have the ability to activate, set the messaging mode of, and deactivate all subordinate nodes belonging to the same distress beacon system through point to multipoint communication. In an example embodiment, subordinate nodes contain light emitters and can only be triggered by a control node from the same distress beacon system. The point to multipoint communications used by the beacon designs can involve either wired or wireless solutions or a hybrid of the two. Thus, in an example embodiment, components of the beacon system are divided into modules and nodes and configured to support point-multipoint node communication.

Additionally, modules/nodes can be configured to communicate state and control information over a wired or wireless link, in addition to (de)activation and mode selection described. For example, synchronization of the flashes and Morse code (otherwise, modules flashing at different times can be confusing and inhibit communication). Or if a module fails, other modules pointing in the same direction can be controlled to boost their strength/brightness.

In addition to the cubesat example embodiment, other distributed designs for beacon systems can be implemented. For example, the microcontroller can be interfaced with a short-range wireless transmitter, and placed on the front of astronaut's spacesuit. Multiple PCBs, similar in size to a credit card, with a wireless receiver, a battery, a power regulator, and a reduced number of LEDs, possibly 2 visible and 1 IR, can be placed on the astronaut's suit in multiple locations. Similar to the cubesat-based embodiment, once the microcontroller is commanded to operate (external signal, astronaut, or fail-safe), the wireless transmitter sends a command to the other indicators which then start to operate in the commanded mode. Since these small cards are placed on the suit in multiple locations, they form an array that is visible from all angles, are compatible with the astronaut's work, are lightweight, and minimize local heat dissipation.

Modular distress beacon designs greatly expand the utility of space distress beacon systems by allowing the system to incorporate as many emitters as necessary at whatever locations on the space-suit (or other support structure) necessary to allow for omni-directional distress signal visibility. By separating distress beacons into multiple self-contained nodes, the point-multipoint communication feature also helps to isolate the entire distress-beacon system from the effects of single node failures, thus increasing reliability.

All of these features combine to make the distress beacon system herein described more functional and versatile than any currently available distress beacon and thus give it a significant competitive advantage. Since this beacon is designed for space use, the design also incorporates reliable heat dissipation and operation in zero-atmosphere environments. These two features in particular make such a device highly advantageous for implementation in space-based visual distress beacons.

In various embodiments, beacon systems and modules are configured to allow a user (e.g., an endangered astronaut) to easily and quickly select between various predetermined messages (e.g., distress messages) and/or a substantially automated (e.g., single input) triggering mechanism. For example, a beacon system or module is configured to support a broad-range of user-selectable display patterns, including always on and messaging modes, without the need for any sort of hardware reconfiguration or system reprogramming.

In an example embodiment, at least one processor is programmed to selectively control the beacon system in one of multiple operational modes. By way of example, the multiple operational modes can include a pre-programmed message mode (e.g., a repeating SOS pattern) and a flare mode (e.g., all emitters energized).

The multiple operational modes can include a manual transmission mode (e.g., the astronaut uses the input device 108 to actuate emitters to generate a Morse code transmission).

In another example embodiment, at least one processor is programmed to automatically execute a pre-programmed operation in response to a fail safe input, and/or to execute a pre-programmed operation in response to a single input.

In another example embodiment, at least one processor is programmed to respond to an input generated external to the beacon system, to manually generated inputs, and/or to an input generated by a sensor.

In example embodiments, beacon systems and modules are configured to accept one or more external signals as a trigger for device activation. These triggers, in conjunction with medical sensors in an astronaut's suit, for example, can be controlled to cause the device to automatically activate in the case of a medical emergency. Such triggers can also be used to remotely activate the distress beacon in the event that an astronaut has stopped responding to radio messages.

In example embodiments, beacon systems and modules are configured to facilitate user-selectable display modes. The available display modes include, by way of example, pre-programmed messaging mode and high-visibility flashing modes. In the event that the astronaut is incapacitated or otherwise unable to select a display mode, in an example embodiment, the device will operate in a default display mode. The device may also incorporate a manual transmission mode, whereby astronauts will be able to manually enter, for example, Morse code or similarly encoded messages for transmission. The pre-programmed message mode includes, for example, messages such as SOS and may also be used to transmit the astronaut's GPS coordinates.

In an example embodiment, at least one processor is programmed to facilitate selection from one of a plurality of different predetermined display patterns. By way of example, a flashing pattern is controlled for a green LED @ 5 Hz, on 20% of the time.

The plurality of different display patterns includes, for example, a high visibility display pattern in which all of the visible light sources are controlled to flash at maximum brightness, and an “always on” display pattern in which all of the visible light sources are controlled to remain always on, rather than flash. The visible light sources can be controlled in other ways. By way of example, and as shown in FIG. 7, the visible light sources can be controlled to flash at 33% brightness.

Example embodiments of beacon systems and modules described herein address the problem of omni-directional visibility by allowing a single distress beacon to include any number of centrally triggered emitting units that are placed to provide viewing from any angle.

Although various beacon systems and modules described herein are specifically designed for use by astronauts during space walks, the underlying principles can be applied to any search and rescue operation, particularly where visual indications of an individual's location are desired. Such applications may include but are not limited to: locating subjects in the open sea, locating subjects in the forests, and keeping track of search and rescue teams.

Although the present invention has been described in terms of the example embodiments above, numerous modifications and/or additions to the above-described embodiments would be readily apparent to one skilled in the art. It is intended that the scope of the present invention extend to all such modifications and/or additions.

What is claimed is:

1. A beacon system, comprising:
a plurality of emitter devices including visible light sources that are oriented to provide omni-directional visibility for the beacon system;
driver circuitry configured for controlling the emitter devices; and
at least one processor programmed to receive and process one or more inputs and control the driver circuitry to actuate the emitter devices.

2. The beacon system of claim 1, wherein components of the beacon system including the emitter devices, driver circuitry and at least one processor are configured such that in a space environment heat generated by the beacon system is dissipated sufficiently well to prevent the beacon system from overheating.

3. The beacon system of claim 1, wherein the beacon system includes one or more printed circuit boards upon which the driver circuitry and the at least one processor are mounted.

4. The beacon system of claim 1, wherein the emitter devices include different types of emitter devices.

5. The beacon system of claim 1, wherein the emitter devices include a visible light LED.

6. The beacon system of claim 1, wherein the emitter devices include an IR LED.

7. The beacon system of claim 1, wherein the emitter devices include a RF transmitter.

8. The beacon system of claim 1, wherein the at least one processor is programmed to facilitate selection from one of a plurality of different predetermined display patterns.

9. The beacon system of claim 8, wherein the plurality of different display patterns includes a high visibility display pattern in which all of the visible light sources are controlled to flash at maximum brightness.

10. The beacon system of claim 8, wherein the plurality of different display patterns includes an always on display pattern in which all of the visible light sources are controlled to remain always on, rather than flash.

11. The beacon system of claim 1, wherein the at least one processor is programmed to selectively control the beacon system in one of multiple operational modes.

12. The beacon system of claim 11, wherein the multiple operational modes include a pre-programmed message mode.

13. The beacon system of claim 11, wherein the multiple operational modes include a manual transmission mode in which one or more of the emitter devices can be controlled to transmit messages in Morse code.

14. The beacon system of claim 1, wherein the at least one processor is programmed to automatically execute a pre-programmed operation in response to a fail safe input.

15. The beacon system of claim 1, wherein the at least one processor is programmed to execute a pre-programmed operation in response to a single input.

16. The beacon system of claim 1, wherein the at least one processor is programmed to respond to an input generated external to the beacon system.

17. The beacon system of claim 1, wherein the at least one processor is programmed to respond to manually generated inputs.

18. The beacon system of claim 1, wherein the at least one processor is programmed to respond to an input generated by a sensor.

19. The beacon system of claim 1, further including:
a sensor configured for providing inputs to the at least one processor.

20. The beacon system of claim 1, further including:
a remote control configured for providing inputs to the at least one processor.

21. The beacon system of claim 1, wherein components of the beacon system are divided into modules and nodes and configured to support point-multipoint node communication.

22. The beacon system of claim 1, wherein components of the beacon system are configured to be connected to a space suit.

23. The beacon system of claim 1, wherein components of the beacon system are configured to be connected to a satellite.

24. A beacon system, comprising:
a plurality of emitter devices;
driver circuitry configured for controlling the emitter devices; and
at least one processor programmed to receive and process one or more inputs and control the driver circuitry to actuate the emitter devices;
wherein components of the beacon system including the emitter devices, driver circuitry and at least one processor are configured such that in a space environment heat generated by the beacon system is dissipated sufficiently well to prevent the beacon system from overheating.

25. The beacon system of claim 24, wherein the beacon system includes one or more printed circuit boards upon which the driver circuitry and the at least one processor are mounted.

26. The beacon system of claim 24, wherein the emitter devices include different types of emitter devices.

27. The beacon system of claim 24, wherein the emitter devices include a visible light LED.

28. The beacon system of claim 24, wherein the emitter devices include an IR LED.

29. The beacon system of claim 24, wherein the emitter devices include a RF transmitter.

30. The beacon system of claim 24, wherein the emitter devices include visible light sources which are oriented to provide omni-directional visibility.

31. The beacon system of claim 24, wherein the at least one processor is programmed to facilitate selection from one of a plurality of different predetermined display patterns.

32. The beacon system of claim 31, wherein the emitter devices include visible light sources, and the plurality of different display patterns includes a high visibility display pattern in which all of the visible light sources are controlled to flash at maximum brightness.

33. The beacon system of claim 31, wherein the emitter devices include visible light sources, and the plurality of different display patterns includes an always on display pattern in which all of the visible light sources are controlled to remain always on, rather than flash.

34. The beacon system of claim 24, wherein the at least one processor is programmed to selectively control the beacon system in one of multiple operational modes.

35. The beacon system of claim 34, wherein the multiple operational modes include a pre-programmed message mode.

36. The beacon system of claim 34, wherein the multiple operational modes include a manual transmission mode in which one or more of the emitter devices can be controlled to transmit messages in Morse code.

37. The beacon system of claim 24, wherein the at least one processor is programmed to automatically execute a pre-programmed operation in response to a fail safe input.

38. The beacon system of claim 24, wherein the at least one processor is programmed to execute a pre-programmed operation in response to a single input.

39. The beacon system of claim 24, wherein the at least one processor is programmed to respond to an input generated external to the beacon system.

40. The beacon system of claim 24, wherein the at least one processor is programmed to respond to manually generated inputs.

41. The beacon system of claim 24, wherein the at least one processor is programmed to respond to an input generated by a sensor.

42. The beacon system of claim 24, further including:
a sensor configured for providing inputs to the at least one processor.

43. The beacon system of claim 24, further including:
a remote control configured for providing inputs to the at least one processor.

44. The beacon system of claim 24, wherein components of the beacon system are divided into modules and nodes and configured to support point-multipoint node communication.

45. The beacon system of claim 24, wherein components of the beacon system are configured to be connected to a space suit.

46. The beacon system of claim 24, wherein components of the beacon system are configured to be connected to a satellite.

47. A beacon system, comprising:
a supporting structure; and
a plurality of beacon modules secured to the supporting structure, each of the beacon modules including
a plurality of emitter devices including at least one visible light source that are oriented to provide omni-directional visibility for the beacon system,
driver circuitry configured for controlling the emitter devices, and
a processor programmed to receive and process one or more inputs and control the driver circuitry to actuate the emitter devices.

48. The beacon system of claim 47, wherein the beacon modules each include a plurality of visible light sources.

49. The beacon system of claim 47, wherein each beacon module includes a wireless transmitter and the beacon modules are divided into control modules and control/subordinate nodes and configured to support point-multipoint node communication.

50. The beacon system of claim 47, wherein the beacon modules are thermally coupled to a portion of the supporting structure that is made from a material capable of dissipating heat generated by the emitter devices and driver circuitry.

51. The beacon system of claim 50, wherein the material is made from aluminum.

52. The beacon system of claim 51, wherein the external surface area of the portion of the supporting structure in thermal contact with the beacon module is at least 12.0 cm².

53. The beacon system of claim 47, wherein the supporting structure is configured to be worn on the body.

54. The beacon system of claim 47, wherein the supporting structure is a space suit.

55. The beacon system of claim 47, wherein the supporting structure is a satellite.

56. The beacon system of claim 47, wherein components of the beacon modules including the emitter devices, driver circuitry and processors are configured such that in a space environment heat generated by the beacon modules is dissipated sufficiently well to prevent the beacon modules from overheating.

57. The beacon system of claim 47, wherein the beacon modules each include a printed circuit board upon which the driver circuitry and the processor are mounted.

58. The beacon system of claim 47, wherein the beacon modules are operably interconnected with the supporting structure.

59. The beacon system of claim 47, wherein one or more of the beacon modules is configured to receive an input from the supporting structure.

60. The beacon system of claim 47, wherein one or more of the beacon modules is configured to receive an input generated external to the beacon system.

61. The beacon system of claim 47, wherein the emitter devices include different types of emitter devices.

62. The beacon system of claim 47, wherein the emitter devices include a visible light LED.

63. The beacon system of claim 47, wherein the emitter devices include an IR LED.

64. The beacon system of claim 47, wherein the emitter devices include a RF transmitter.

65. The beacon system of claim 47, wherein one or more of the processors is programmed to facilitate selection from one of a plurality of different predetermined display patterns.

66. The beacon system of claim 65, wherein the plurality of different display patterns includes a high visibility display pattern in which all of the visible light sources are controlled to flash at maximum brightness.

67. The beacon system of claim 65, wherein the plurality of different display patterns includes an always on display pattern in which all of the visible light sources are controlled to remain always on, rather than flash.

68. The beacon system of claim 47, wherein one or more of the processors is programmed to selectively control the beacon system in one of multiple operational modes.

69. The beacon system of claim 68, wherein the multiple operational modes include a pre-programmed message mode.

70. The beacon system of claim 68, wherein the multiple operational modes include a manual transmission mode in which one or more of the emitter devices can be controlled to transmit messages in Morse code.

71. The beacon system of claim 47, wherein one or more of the processors is programmed to automatically execute a pre-programmed operation in response to a fail safe input.

72. The beacon system of claim 47, wherein one or more of the processors is programmed to execute a pre-programmed operation in response to a single input.

73. The beacon system of claim 47, wherein one or more of the processors is programmed to respond to an input generated external to the beacon system.

74. The beacon system of claim 47, wherein one or more of the processors is programmed to respond to manually generated inputs.

75. The beacon system of claim 47, wherein one or more of the processors is programmed to respond to an input generated by a sensor.

76. The beacon system of claim 47, further including:
a sensor configured for providing inputs to one or more of the processors.

77. The beacon system of claim 47, further including:
a remote control configured for providing inputs to one or more of the processors.
